(19) United States
(12) Patent Application Publication
(10) Pub. No.: US 2025/0275585 A1
(43) Pub. Date: Sep. 4, 2025

(54) AEROSOL PROVISION SYSTEM AND METHOD

(71) Applicant: NICOVENTURES TRADING LIMITED, London (GB)

(72) Inventors: Gilles MEYER, Paris (FR); Vincent HAYWARD, Paris (FR)

(21) Appl. No.: 18/858,077

(22) PCT Filed: Apr. 18, 2023
(86) PCT No.: PCT/GB2023/051018

§ 371 Date: Oct. 18, 2024

(30) Foreign Application Priority Data
Apr. 20, 2022 (GB) 2205741.8

(51) Int. Cl. A24F 40/53; A24F 40/10; A24F 40/42; A24F 40/465; A24F 40/485; A24F 40/51; G06F 3/01

(52) U.S. Cl. CPC A24F 40/53; A24F 40/42; A24F 40/465; A24F 40/51; G06F 3/016; A24F 40/10; A24F 40/485

(57) ABSTRACT

An aerosol provision system comprises a haptic component and control circuitry. The control circuitry is configured to adjust a setting of the haptic component in response to determining that an inhalation on the aerosol provision system is about to occur.

### TECHNICAL FIELD

The present invention relates to an aerosol provision system and method.

### BACKGROUND

Electronic aerosol provision systems such as electronic cigarettes (e-cigarettes) generally contain an aerosol-generating material, such as a reservoir of a source liquid containing a formulation, typically including nicotine, or a solid material such as a tobacco-based product, from which an aerosol is generated for inhalation by a user, for example through heat vaporisation. Thus, an aerosol provision system will typically comprise an aerosol generator, e.g. a heating element, arranged to aerosolise a portion of aerosol-generating material to generate an aerosol in an aerosol generation region of an air channel through the aerosol provision system. As a user inhales on the device and electrical power is supplied to the aerosol generator, air is drawn into the device through one or more inlet holes and along the air channel to the aerosol generation region, where the air mixes with the vaporised aerosol generator and forms a condensation aerosol. The air drawn through the aerosol generation region continues along the air channel to a mouthpiece, carrying some of the aerosol with it, and out through the mouthpiece for inhalation by the user.

It is common for aerosol provision systems to comprise a modular assembly, often having two main functional parts, namely an aerosol provision device and an article. Typically, the article will comprise the article aerosol-generating material and the aerosol generator (heating element), while the aerosol provision device part will comprise longer-life items, such as a rechargeable battery, device control circuitry and user interface features. The aerosol provision device may also be referred to as a reusable part or battery section and the article may also be referred to as a consumable, disposable/replaceable part, cartridge or cartomiser.

The aerosol provision device and article are mechanically coupled together at an interface for use, for example using a screw thread, bayonet, latched or friction fit fixing. When the aerosol-generating material in an article has been exhausted, or the user wishes to switch to a different article having a different aerosol-generating material, the article may be removed from the aerosol provision device and a replacement article may be attached to the device in its place.

Haptic components or elements can form a part of the aerosol provision system and be used to provide a sensory signal or sensation to the user. Determining how and when to provide such a signal such that the user is able to detect and interpret/understand the signal can be challenging.

Various approaches are described herein which seek to help address or mitigate some of the issues discussed above.

### SUMMARY

The disclosure is defined in the appended claims.

In accordance with some embodiments described herein, there is provided an aerosol provision system comprising a haptic component and control circuitry. The control circuitry is configured to adjust a setting of the haptic component in response to determining that an inhalation on the aerosol provision system is about to occur.

The aerosol provision system can further comprise one or more sensors, and wherein the control circuitry is configured determine the inhalation is about to occur based on signals received from one or more sensors. One of the sensors can be configured to detect if the aerosol generating system is connected to an external power source. One of the sensors can be configured to measure ambient noise around the aerosol provision system. One of the sensors can be configured to measure ambient light around the aerosol provision system. One of the sensors can be configured to measure an orientation and/or movement of the aerosol provision system. One of the sensors can be configured to detect if the user is touching or within proximity of the aerosol provision system.

The aerosol provision system can further comprise a mouthpiece. One of the sensors can be configured to detect if the user is touching or within proximity of the mouthpiece. One of the sensors can be configured to detect a pressure change at the mouthpiece.

Adjusting the setting of the haptic component can correspond to enabling the haptic component.

The setting can be an amplitude and/or frequency of a vibration generated by the haptic component. The setting can be a magnitude of a force generated by the haptic component.

The aerosol provision system can further comprise a display component, and the control circuitry is further configured to adjust a setting of the display component based on the determined orientation. The setting can be a brightness of the display component. Adjusting the setting of the display component can correspond to disabling the display component.

The aerosol provision system can further comprise a speaker component, and the control circuitry is further configured to adjust a setting of the speaker component based on the determined orientation. The setting can be a volume of the speaker component. Adjusting the setting of the speaker component can correspond to disabling the speaker component.

The aerosol provision system can further comprise a communications interface, and wherein control circuitry is further configured to adjust a setting of the haptic component based on a signal received via the communications interface from an external device.

The aerosol provision system can further comprise an input device, and wherein control circuitry is further configured to adjust a setting of the haptic component based on an input received via the input device.

In accordance with some embodiments described herein, there is provided an aerosol provision device for an aerosol provision system, the aerosol provision system comprising a haptic component, wherein the aerosol provision device comprises control circuitry configured to adjust a setting of the haptic component in response to determining that an inhalation on the aerosol provision system is about to occur.

In accordance with some embodiments described herein, there is provided a method for operating an aerosol provision system comprising adjusting a setting of a haptic component of the aerosol provision system in response to determining that an inhalation on the aerosol provision system is about to occur.

There is also provided a computer readable storage medium comprising instructions which, when executed by a processor, performs the above method.

These aspects and other aspects will be apparent from the following detailed description. In this regard, particular sections of the description are not to be read in isolation from other sections.

### BRIEF DESCRIPTION OF DRAWINGS

Embodiments of the invention will now be described, by way of example only, with reference to accompanying drawings, in which:

FIG. 1 is a schematic diagram of an aerosol provision system;

FIG. 2 is a flow diagram of a method for operating an aerosol provision system.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of articles and systems discussed herein which are not described in detail may be implemented in accordance with any conventional techniques for implementing such aspects and features.

The present disclosure relates to aerosol provision systems, which may also be referred to as vapour provision systems, such as e-cigarettes. Throughout the following description the term “e-cigarette” or “electronic cigarette” may sometimes be used, but it will be appreciated this term may be used interchangeably with aerosol provision system and electronic aerosol provision system.

As noted above, aerosol provision systems (e-cigarettes) often comprise a modular assembly including both a reusable part (aerosol provision device) and a replaceable (disposable) or refillable cartridge part, referred to as an article. Systems conforming to this type of two-part modular configuration may generally be referred to as two-part systems or devices. It is also common for electronic cigarettes to have a generally elongate shape. For the sake of providing a concrete example, certain embodiments of the disclosure described herein comprise this kind of generally elongate two-part system employing refillable cartridges. However, it will be appreciated the underlying principles described herein may equally be adopted for other electronic cigarette configurations, for example modular systems comprising more than two parts, as devices conforming to other overall shapes, for up example based on so-called box-mod high performance devices that typically have a more boxy shape, or even systems comprising one part where the aerosol provision device and article are integrally formed with one another.

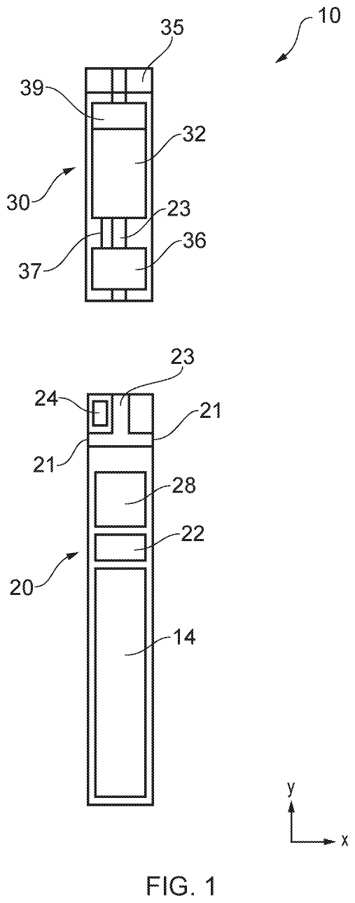

FIG. 1 is a highly schematic diagram (not to scale) of an example aerosol provision system 10, such as an e-cigarette, to which embodiments are applicable. The aerosol provision system 10 has a generally cylindrical shape, extending along a longitudinal or y axis as indicated by the axes (although aspects of the invention are applicable to e-cigarettes configured in other shapes and arrangements), and comprises two main components, namely an aerosol provision device 20 and an article 30.

The article 30 comprises or consists of aerosol-generating material 32, part or all of which is intended to be consumed during use by a user. An article 30 may comprise one or more other components, such as an aerosol-generating material storage area 39, an aerosol-generating material transfer component 37, an aerosol generation area, a housing, a wrapper, a mouthpiece 35, a filter and/or an aerosol-modifying agent.

An article 30 may also comprise an aerosol generator 36, such as a heating element, that emits heat to cause the aerosol-generating material 32 to generate aerosol in use. The aerosol generator 36 may, for example, comprise combustible material, a material heatable by electrical conduction, or a susceptor. It should be noted that it is possible for the aerosol generator 36 to be part of the aerosol provision device 20 and the article 30 then may comprise the aerosol-generating material storage area 39 for the aerosol-generating material 32 such that, when the article 30 is coupled with the aerosol provision device 20, the aerosol-generating material 32 can be transferred to the aerosol generator 36 in the aerosol provision device 20. It should be appreciated that the aerosol generator 36 may encompass an aerosol generator other than a heater. More generally, an aerosol generator is an apparatus configured to cause aerosol to be generated from the aerosol-generating material. In some other embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

Aerosol-generating material is a material that is capable of generating aerosol, for example when heated, irradiated or energized in any other way. The aerosol-generating material 32 may, for example, be in the form of a solid, liquid or gel which may or may not contain an active substance and/or flavourants. In some embodiments, the aerosol-generating material 32 may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material 32 may for example comprise from about 50 wt %, 60 wt% or 70 wt % of amorphous solid, to about 90 wt %, 95 wt% or 100 wt % of amorphous solid.

The aerosol-generating material comprises one or more ingredients, such as one or more active substances and/or flavourants, one or more aerosol-former materials, and optionally one or more other functional materials such as pH regulators, colouring agents, preservatives, binders, fillers, stabilizers, and/or antioxidants.

The active substance as used herein may be a physiologically active material, which is a material intended to achieve or enhance a physiological response. The active substance may for example be selected from nutraceuticals, nootropics, and psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

The aerosol provision device 20 includes a power source 14, such as a battery, configured to supply electrical power to the aerosol generator 36. The power source 14 in this example is rechargeable and may be of a conventional type, for example of the kind normally used in electronic cigarettes and other applications requiring provision of relatively high currents over relatively short periods. The power source 14 may be recharged through the charging port (not illustrated), which may, for example, comprise a USB connector.

The aerosol provision device 20 includes device control circuitry 28 configured to control the operation of the aerosol provision system 10 and provide conventional operating functions in line with the established techniques for controlling aerosol provision systems such as electronic cigarettes. The device control circuitry (processor circuitry) 28 may be considered to logically comprise various sub-units/circuitry elements associated with different aspects of the electronic cigarette's operation. For example, depending on the functionality provided in different implementations, the (device) control circuitry 28 may comprise power source control circuitry for controlling the supply of electrical power from the power source 14 to the aerosol generator 36, user programming circuitry for establishing configuration settings (e.g. user-defined power settings) in response to user input, as well as other functional units/circuitry associated functionality in accordance with the principles described herein and conventional operating aspects of electronic cigarettes. It will be appreciated the functionality of the (device) control circuitry 28 can be provided in various different ways, for example using one or more suitably programmed programmable computer(s) and/or one or more suitably configured application-specific integrated circuit(s)/circuitry/chip(s)/chipset(s) configured to provide the desired functionality.

The aerosol provision device 20 has an interface configured to receive the article 30, thereby facilitating the coupling between the aerosol provision device 20 and the article 30. The interface is located on a surface of the aerosol provision device 20.

The housing of the article 30 has a surface configured to be received by the interface on the aerosol provision device 20 in order to facilitate coupling between the article 30 and the aerosol provision device 20. The surface of the article may be configured to be a size and/or shape that mirrors the size and/or shape of the interface in order to facilitate coupling between the aerosol provision device 20 and the article 30. For example, the interface may comprise a cavity, chamber or other space on the surface of the aerosol provision device 20. The surface of the article 30 can then be configured to be a size and shape that mirrors the size and shape of the cavity in order for the surface of the article 30 to be inserted into the cavity.

Although not illustrated, the interface of the aerosol provision device 20 and the surface of the article 30 may have complementary features to reversibly attach and mate the article 30 to the aerosol provision device 20, such as a screw thread, bayonet fitting, latched or friction fit fixing or other fastening means.

The interface also comprises one or more connectors, such as contact electrodes, connected via electrical wiring to the control circuitry 28 and the power source 14. The article 30 also comprises one or more connectors, such as contact electrodes, connected via electrical wiring to the aerosol generator 36. In use, the article 30 is received by the interface of the aerosol provision device 20, thereby coupling the aerosol provision device 20 and the article 30. This results in the connectors on the article 30 mating with the connectors on the aerosol provision device 20, thereby allowing electrical power and electrical current to be supplied from the power source 14 of the aerosol provision device 20 to the aerosol generator 36 of the article 30.

The housing of the article 30 has a surface configured to engage with an interface on the aerosol provision device 20 in order to facilitate coupling between the article 30 and the aerosol provision device 20. In other words, the aerosol provision device 20 is configured to receive the article 30, via the interface, and the surface of the article is proximate to the interface on the aerosol provision device 20 when the article 20 is received by the interface.

The aerosol provision system 10 includes one or more air inlets 21, located on one or more of the aerosol provision device 20 and the article 30. In use, as a user inhales on the mouthpiece 35, air is drawn into the aerosol provision system 10 through the air inlets 21 and along an air channel 23 to the aerosol generator 36, where the air mixes with the vaporised aerosol-generating material 32 and forms a condensation aerosol. The air drawn through the aerosol generator 36 continues along the air channel 23 to a mouthpiece 35, carrying some of the aerosol with it, and out through the mouthpiece 35 for inhalation by the user.

By way of a concrete example, the article 30 comprises a housing (formed, e.g., from a plastics material), an aerosol-generating material storage area 39 formed within the housing for containing the aerosol-generating material 32 (which in this example may be a liquid which may or may not contain nicotine), an aerosol-generating material transfer component 37 (which in this example is a wick formed of e.g., glass or cotton fibres, or a ceramic material configured to transport the liquid from the reservoir using capillary action), an aerosol-generating area containing the aerosol generator 36, and a mouthpiece 35. Although not shown, a filter and/or aerosol modifying agent (such as a flavour imparting material) may be located in, or in proximity to, the mouthpiece 35. The aerosol generator 36 of this example comprises a heater element formed from an electrically resistive material (such as NiCr8020) spirally wrapped around the aerosol-generating material transfer component 37, and located in an air channel 23. The area around the heating element and wick combination is the aerosol-generating area of the article 30.

As illustrated in FIG. 1, the aerosol provision system 10 also comprises a haptic component 22. The haptic component 22 is configured to generate one or more vibrations and/or forces in order to provide a haptic sensation to the user of the aerosol provision system 10. The haptic component 22 can comprise any suitable component configured to provide a haptic sensation (feedback) to a user. For example, the haptic component 22 may comprise an eccentric rotating mass (ERM) or linear resonant actuator (LRA) haptic component. The haptic component 22 may comprise a piezoelectric actuator configured to produce one more vibrations, and/or the haptic component 22 can comprise a motor configured to produce one or more forces. For example, a pneumatic motor, valve and/or fan can be used to generate a puff, pulse or other movement of air that may be sensed by the user of the aerosol provision system 10. Additionally, or alternatively, the haptic component 22 may generate haptic sensations that do not directly result from a motion (e.g., vibration) of a mass or of air; e.g., the haptic component 22 may be configured to generate a haptic sensation via an electromagnetic field or via an electric pulse, for example.

The haptic component 22 can be located on or within the aerosol provision device 20 and/or the article 30. For example, the haptic component 22 can be located proximate to or forming part of the housing of the aerosol provision device 20 such that the vibrations and/or forces generated by the haptic component 22 can be felt by the user of the aerosol provision system 10 when the user of the aerosol provision system 10 is holding the aerosol provision device 20. The aerosol provision system 10 may comprise more than one haptic component 22, for example one located proximate to or forming part of the housing of the aerosol provision device 20 and one located proximate to or forming part of the article 30, such as on the mouthpiece 35 such that the vibrations/forces generated by the haptic component 22 are sensed on the lips of the user during an inhalation.

The haptic component 22 can be operatively coupled to the power source 14 of the aerosol provision device 20 in order to receive electrical power, and the haptic component 22 can be operatively coupled to the control circuitry 28 such that the control circuitry 28 can be configured to control the haptic component 22.

The control circuitry 28 is configured to adjust a setting of the haptic component 22 in response to determining that an inhalation on the aerosol provision system is about to occur. As described above, in order to use the aerosol provision system 10, the user inhales, sucks or otherwise draws on the aerosol provision system 10 in order to cause aerosol to be generated and delivered into the mouth of the user. The control circuitry 28 is configured to determine that such an inhalation on the aerosol provision system is about to occur. In other words, the control circuity 28 is configured to anticipate or otherwise predict when an inhalation is going to occur.

For example, the aerosol provision system 10 may comprise a button, switch or other form of input device which the user is required hold or actuate in order to perform an inhalation on the aerosol provision system 10. The input device may be connected to the aerosol generator 36 such that the aerosol generator 36 is only enabled when the input device is held or actuated by the user. The control circuitry 28 can be configured to determine the inhalation is about to occur based on an input on the input device.

Equally, the control circuitry 28 can be configured determine the inhalation is about to occur based on signals received from the one or more sensors. The aerosol provision system 10 illustrated in FIG. 1 comprises one or more sensors 24. The one or more sensors 24 can be located on or within the aerosol provision device 20 and/or the article 30. The one or more sensors 24 are operatively coupled to the power source 14 of the aerosol provision device 20 in order to receive electrical power, and the one or more sensors 24 are operatively coupled to the control circuitry 28 such that the control circuitry 28 can be configured to control the one or more sensors 24. The control circuity 28 is then configured to determine the inhalation is about to occur based on signals received from the one or more sensors 24. In other words, the control circuit 28 is configured to read or otherwise receive readings from the one or more sensors 24, and use the readings to determine whether an inhalation is about to occur. The control circuitry 28 can receive readings from the sensors 24 periodically, for example every second, minute or five minutes, or the control circuitry 28 can send a request to the sensors 24 for the one or more readings. Equally, the control circuitry 28 can be configured to determine whether an inhalation is about to occur in response to an event, for example one or more readings from the sensors 24 changing.

One of the sensors 24 can be configured to detect if the aerosol generating system 10 is connected to an external power source. For example, one of the sensors 24 can comprise a current sensor configured to measure an amount of current received from an external power supply. When the power source or battery 14 of the aerosol provision system 10 needs to be recharged, the aerosol provision system 10 can be connected to an external power supply in order to recharge the power source or battery 14. The current sensor can be located between the power source 14 and charging port of the aerosol provision system 10 in order to measure current flow between the external power supply and the power source 14 (i.e. to measure or otherwise detect when the aerosol provision system 10 is connected to an external power supply). It will be appreciated that users typically do not inhale on an aerosol provision system 10 whilst it is being recharged (i.e. whilst aerosol provision system 10 is connected to the external power supply).

One of the sensors 24 can be configured to measure ambient noise around the aerosol provision system 10. For example, one of the sensors 24 can comprise microphone configured to measure the amount of noise proximate to the aerosol provision system 10. Equally, the microphone or other noise sensor could be located proximate to the air inlets 21 and/or air channel 23 in order to detect noise associated with the flow of air into and through the air channel 23. The sensor is then able to detect when air begins to flow into and through the air channel 23, thereby indicating that the user is about to start or begin an inhalation. Additionally or alternatively, the microphone or other noise sensor may be configured to detect changes of the airflow into and through the air channel 23 resulting from movement of the aerosol provision system 10. For example, this airflow may be from the aerosol provision system 10 being moved towards the user's mouth. Additionally or alternatively, the microphone or other noise sensor may be configured to detect a sound resulting from a user's physical interaction with the aerosol provision system, e.g., the sound of a button click, the sound of the user gripping the aerosol provision system 10, etc.

One of the sensors 24 can be configured to measure ambient light around the aerosol provision system 10. For example, one of the sensors 24 can comprise an optical sensor configured to measure the amount of light proximate to the aerosol provision system 10. _{[MB(1]}When the user is holding the aerosol provision system 10 and about to inhale on the aerosol provision system 10, the user's hand, lips or other part of the user's body may partially or completely obscure the optical sensor, thereby reducing the amount of light proximate to the aerosol provision system and detected by the optical sensors. The optical sensor can be located on a portion of the aerosol provision system 10, such as the body of the aerosol provision device 20 or the mouthpiece 35, where a user typically holds or touches the aerosol provision system 10 such that the amount of light detected by the optical sensors is indicative of whether or not the user is holding or touching the aerosol provision system 10, since the user needs to touch the aerosol provision system 10 in order to perform an inhalation.

One of the sensors 24 can be configured to detect if the user is touching the aerosol provision system. For example, one of the sensors 24 can comprise a capacitive sensor, pressure sensor or other form of touch sensor. Such a touch sensor can be located on the body of the aerosol provision system 10, for example on the aerosol provision device 20, in order to detect if the user is holding or otherwise touching the aerosol provision system 10 with their hand. Equally, as described above, the aerosol provision system 10 can comprise a mouthpiece 35, and the one of the sensor 24 can be configured to detect if the user is touching the mouthpiece 35. For example, one of the sensors 24 a touch sensor located on the mouthpiece 35 and configured to detect if the user is touching the mouthpiece (e.g. with their lips or other part of their mouth), since the user needs to touch the aerosol provision system 10 in order to perform an inhalation. In some implementations, the one of the sensors 24 may be configured to detect whether the user is in proximity of the aerosol provision system 10. For example, some capacitive sensors may be operated to detect a hand (or conductive object) a few centimetres from the surface of the capacitive touch sensor.

One of the sensors 24 can be configured to detect a pressure change at the mouthpiece 35. For example, one of the sensors 24 can comprise pressure sensor located in or proximate to the exit of the air channel 23 through the mouthpiece such that a pressure change at the mouthpiece can be detected. Equally, the pressure sensor can be located on or proximate to the mouthpiece and configured to detect a pressure change at the mouthpiece outside of the air channel 23, for example a pressure change associate with the user putting the mouthpiece in their mouth. As will be appreciated, before beginning an inhalation, the user will place at least the mouthpiece 35 of the aerosol provision system 10 into their mouth and form a seal on the aerosol provision system 10 with their lips. This will result in a change in air pressure, which one of the sensors 24 can be configured to detect.

One of the sensors 24 can be configured to measure an orientation and/or movement of the aerosol provision system 10. For example, one of the sensors 24 can comprise a gyroscope, such as the microelectromechanical systems (MEMS) gyroscope or gyrometer, a 6 or 9 axis accelerometer, a MEMS accelerometer and/or an Inertial Measurement Unit (IMU). The orientation of the aerosol provision system 10 measured by the accelerometer can indicate whether the aerosol provision system 10 is located on a horizontal flat surface (i.e. along the x-axis in FIG. 1), or whether the aerosol provision system 10 is in a different orientation such as with the article 30 pointing substantially downwards (i.e. with the mouthpiece 35 being at the lowest point on the aerosol provision system 10, in opposite orientation in the y-direction to that illustrated in FIG. 1). The accelerometer can also be configured to measure the motion of the aerosol provision system 10, and therefore detect whether the aerosol provision system 10 is stationary, moving at a constant velocity, or undergoing an acceleration or deceleration. In some implementations, determining that an inhalation on the aerosol provision system is about to occur involves determining when a pattern of motion is detected (for example, corresponding to the motion of raising the aerosol provision system 10 to the user's mouth).

In response to determining that an inhalation on the aerosol provision system is about to occur, the control circuitry 28 is configured to adjust the setting of the haptic component 22. The setting can be one or more of a duration, magnitude, amplitude, frequency and/or pattern of the one or more vibrations or forces generated by the haptic component. For example, the setting can be an amplitude and/or frequency of a vibration generated by the haptic component. The amplitude and/or frequency of the vibration can correspond to a plurality of vibrations, which may form a pattern of vibrations (in other words, one or more adjustments to the amplitude and/or frequency of vibration over time. The pattern might correspond to the haptic component being on (or a vibration being produced) for 1 second, off/stopped for two second, on/produced again for 1 second, or any other suitable pattern involving multiple vibrations over time. Since the aerosol provision component 10 is held by the user during the inhalation, the adjustment to the setting of the haptic component made by the control circuitry 28 will be sensed by the user. This haptic sensation will then be felt during the inhalation, changing the overall sensation of the inhalation and using the aerosol provision system 10, thereby improving the user experience. In some implementations, the haptic sensation during an inhalation may be set so as to be more easily perceived by a user (e.g., the haptic sensation may be relatively stronger). This may relatively increase the level of haptic sensation that the user feels during inhalation acting to modify or enhance the user's experience when inhaling aerosol. In other implementations, the haptic sensation during an inhalation may be set so as to be less easily perceived by a user (e.g., the haptic sensation may be relatively weaker). This may relatively decrease the level of haptic sensation that the user feels during the inhalation meaning any haptic sensation may not detract (or detracts less) from the user's experience. The relative strength of the haptic sensation during an inhalation may be set in view of a particular user experience to be provided.

Equally, the setting can be a duration and/or magnitude of a force generated by the haptic component 22. Adjusting the setting of the haptic component 22 can also correspond to enabling the haptic component 22. In other words, in response to determining that an inhalation on the aerosol provision system is about to occur, the control circuitry 28 can be configured to enable the haptic component 22. For example, the control circuitry 28 can be configured to allow or otherwise enable the supply of electrical power from the power source 14 to the haptic component 22. Equally, adjusting the setting of the haptic component 22 can also correspond to disabling the haptic component 22, for example by preventing the supply of electrical power from the power source 14 to haptic component 22.

The control circuitry 28 can also be configured determine that the inhalation on the aerosol provision system 10 has finished or otherwise been completed in a similar fashion to determining that the inhalation was about to occur, for example based on signals received from the one or more sensors 24 or based on an input on the input device. In response to determining that the inhalation on the aerosol provision system has finished, the control circuitry 28 can be configured to adjust the setting of the haptic component 22 again, for example by undoing or reverse the setting adjustment that was made in response to determining that the inhalation on the aerosol provision system is about to occur. For example, if the amplitude of the vibration generated by the haptic component 22 was increased in response to determining that the inhalation was about to occur, the amplitude of the vibration generated by the haptic component 22 can be decreased in response to determining that the inhalation has finished. Equally, where the haptic component 22 was enabled in response to determining that the inhalation was about to occur, the haptic component 22 can be disabled in response to determining that the inhalation has finished.

Although not illustrated in FIG. 1, the aerosol provision system 10 may comprise one or more output components, such as a display component and/or a speaker component. The control circuitry 28 can be configured to adjust a setting of the display component and/or the speaker component in response to determining that an inhalation on the aerosol provision system is about to occur.

In the case of the display component, the setting of the display component can correspond to a brightness, contrast, colour balance or other visual property of the display component (i.e. the screen of the display component). In the case of the speaker component, the setting of the speaker component can correspond to a volume, balance or other auditory property of the speaker component. Equally, adjusting the setting of the display device and/or speaker component can correspond, respectively, to enabling or disabling the display component and/or speaker component. Adjusting the setting of the display component and/or the speaker component could occur substantially simultaneously with adjusting the setting of the haptic component 22, or in response to adjusting the setting of the haptic component 22. For example, the control circuitry 28 could be configured to adjust the brightness of the display component (e.g. lower the brightness) and/or adjust the volume of the speaker component (e.g. lower the volume) in response to enabling the haptic component 22. Equally, the control circuitry 28 could be configured to disable the display component and/or the speaker component when the haptic component 22 is enabled, then enable the display component and/or the speaker component when the haptic component 22 is disabled. This allows a primary component for conveying signals to the user to be changed between the one or more output components and the haptic component 22.

The aerosol provision system 10 can also comprise a communications interface, and the control circuitry 28 configured to communicate with one or more external devices, such as a computer, mobile phone or other electronic device, via the communications interface. The communications interface can be configured to communicate using a suitable wireless communications protocol such as Wi-Fi, Bluetooth, RFID, NFC. The control circuitry 28 can be configured to adjust a setting of the haptic component 22, such as the settings described above, based on signal received via the communications interface from an external device. In other words, the external device can send a signal to the aerosol provision system 10 by the communications interface, and in response to receiving the signal, the control circuit 28 adjusts a setting of the haptic component 22. This allows the setting of the haptic component 22 to be adjusted without directly interacting with the aerosol provision system 10. The signal received from the external device via the communications interface may indicate the setting and/or magnitude or type of adjustment to be made to the setting of the haptic component 22 to be adjusted, or the control circuitry 28 may be configured to determine the setting of haptic component 22 to adjust based on the signal received from the external device.

The aerosol provision system 10 can also comprise an input device, such as a button, switch, or touchscreen display. In the latter case, the display component described above as an output component can be a touchscreen component that is also configured to receive touch inputs. The control circuitry can be configured to adjust a setting of the haptic component 22, such as the settings described above, based on an input received via the input device. In other words, the user can provide an input on the input device, and in response to receiving the input, the control circuit 28 adjusts a setting of the haptic component 22. This allows the setting of the haptic component 22 to be adjusted by the user providing an input on the aerosol provision system 10. The input received from the input device (e.g. from the user) may indicate the setting and/or magnitude or type of adjustment to be made to the setting of the haptic component 22 to be adjusted, or the control circuitry 28 may be configured to determine the setting of haptic component 22 to adjust based on the input received from the input device.

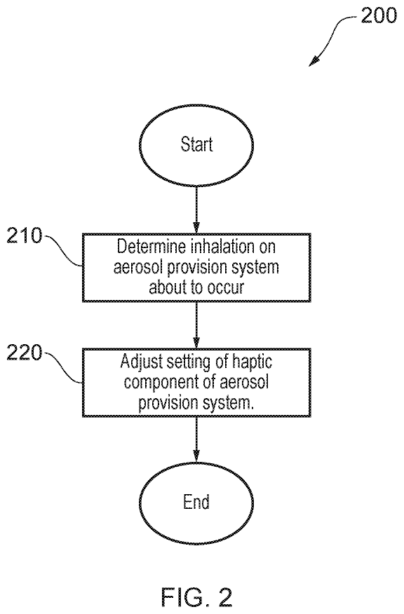

FIG. 2 is a flow diagram of a method 200 for operating an aerosol provision system, such as aerosol provision system 10. The method begins at step 210, where it is determined that an inhalation on the aerosol provision system is about to occur. At step 220, a setting of a haptic component of the aerosol provision system is adjusted. The method then ends.

The method 200 illustrated in FIG. 2 may be stored as instructions on a computer readable storage medium, such that when the instructions are executed by a processor, the method described above is performed. The computer readable storage medium may be non-transitory. In other words, the method 200 illustrated in FIG. 2 may be computer implemented. The method 200 may be performed by the aerosol provision device 20, such as by the control circuitry 28.

As described above, the present disclosure relates to (but it not limited to) an aerosol provision system comprising a haptic component and control circuitry. The control circuitry is configured to adjust a setting of the haptic component in response to determining that an inhalation on the aerosol provision system is about to occur.

Thus, there has been described an aerosol provision system and method.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol provision system comprising:
a haptic component; and
control circuitry configured to adjust a setting of the haptic component in response to determining that an inhalation on the aerosol provision system is about to occur.

2. The aerosol provision system of claim 1, further comprising one or more sensors, and wherein the control circuitry is configured determine the inhalation is about to occur based on signals received from the one or more sensors.

3. The aerosol provision system of claim 2, wherein one of the sensors is configured to detect if the aerosol generating system is connected to an external power source.

4. The aerosol provision system of claim 2, wherein one of the sensors is configured to measure ambient noise around the aerosol provision system.

5. The aerosol provision system of claim 2 4, wherein one of the sensors is configured to measure ambient light around the aerosol provision system.

6. The aerosol provision system of claim 2, wherein one of the sensors is configured to measure an orientation and/or movement of the aerosol provision system.

7. The aerosol provision system of claim 2, wherein one of the sensors is configured to detect if the user is touching or within proximity of the aerosol provision system.

8. The aerosol provision system of claim 2, further comprising a mouthpiece.

9. The aerosol provision system of claim 8, wherein one of the sensors is configured to detect if the user is touching or within proximity of the mouthpiece.

10. The aerosol provision system of claim 8, wherein one of the sensors is configured to detect a pressure change at the mouthpiece.

11. The aerosol provision system of claim 1, wherein adjusting the setting of the haptic component corresponds to enabling the haptic component.

12. The aerosol provision system of claim 1, wherein the setting is an amplitude and/or frequency of a vibration generated by the haptic component.

13. The aerosol provision system of claim 1, wherein the setting is a magnitude of a force generated by the haptic component.

14. The aerosol provision system of claim 1, further comprising a display component, and the control circuitry is further configured to adjust a setting of the display component in response to determining that an inhalation on the aerosol provision system is about to occur.

15. (canceled)

16. The aerosol provision system of claim 14, wherein adjusting the setting of the display component corresponds to disabling the display component.

17. The aerosol provision system of claim 1, further comprising a speaker component, and the control circuitry is further configured to adjust a setting of the speaker component in response to determining that an inhalation on the aerosol provision system is about to occur.

18. (canceled)

19. (canceled)

20. The aerosol provision system of claim 1, further comprising a communications interface, and wherein control circuitry is further configured to adjust a setting of the haptic component based on a signal received via the communications interface from an external device.

21. The aerosol provision system of claim 1, further comprising an input device, and wherein control circuitry is further configured to adjust a setting of the haptic component based on an input received via the input device.

22. An aerosol provision device for an aerosol provision system, the aerosol provision system comprising a haptic component, wherein the aerosol provision device comprises control circuitry configured to:
adjust a setting of the haptic component in response to determining that an inhalation on the aerosol provision system is about to occur.

23. A method for operating an aerosol provision system comprising:
adjusting a setting of a haptic component of the aerosol provision system in response to determining that an inhalation on the aerosol provision system is about to occur.

24. (canceled)
